(19) United States
(12) Patent Application Publication
(10) Pub. No.: US 2012/0127440 A1
(43) Pub. Date: May 24, 2012

(54) OPTICAL ASSEMBLY FOR PROJECTION LITHOGRAPHY

(75) Inventor: Andras G. Major, Oberkochen (DE)

(73) Assignee: CARL ZEISS SMT GMBH, Oberkochen (DE)

(21) Appl. No.: 13/299,658

(22) Filed: Nov. 18, 2011

(30) Foreign Application Priority Data
Nov. 24, 2010 (DE) 10 2010 061 820.9

(51) Int. Cl. G03B 27/54; G01N 21/64

(52) U.S. Cl. 355/30; 250/459.1; 355/67; 355/77; 250/200

(57) ABSTRACT

An optical assembly for projection lithography has an optical component to guide imaging or illumination light. The optical component has a reflective substrate that contains a fluorescent component. An excitation light source is used to produce fluorescence excitation light. An excitation optical system is used to guide the fluorescence excitation light to the fluorescent component of the substrate. The optical assembly also has a fluorescent light detector and a fluorescence optical system for guiding fluorescent light to the fluorescent light detector. The fluorescent light is produced via fluorescence of the fluorescent component upon irradiation with fluorescence excitation light. The optical assembly can detect a temperature or temperature distribution of the substrate of the optical component with a high degree of precision.

### CROSS-REFERENCE TO RELATED APPLICATION

This application claims benefit under 35 U.S.C. §119 to German Application No. 10 2010 061 820.9, filed Nov. 24, 2010. The contents of both of these applications are hereby incorporated by reference in its entirety.

### FIELD

The disclosure relates to an optical assembly for projection lithography, in other words for lithography using the imaging of structures on a lithography mask or a reticle, wherein the optical assembly has an optical component to guide imaging or illumination light. The disclosure also relates to a method for at least locally measuring the temperature of a substrate of an optical component for projection lithography, an illumination optical system with such an optical assembly, a projection optical system with such an optical assembly, a projection exposure system with such an illumination optical system, a projection exposure system with such a projection optical system, a production method for microstructured or nanostructured components using such a projection exposure system, and a microstructured or nanostructured component produced by such a production method.

### BACKGROUND

Optical components for guiding imaging or illumination light within a projection exposure system are known, for example from WO 2009/100856 A1.

### SUMMARY

The present disclosure provides an optical assembly for projection lithography, in which a temperature or temperature distribution of the substrate of the optical component can be detected with a high degree of precision.

The optical fluorescence measurement according to the disclosure allows contactless temperature measurement of the substrate of the optical component. Oscillation or contact problems during the temperature measurement are dispensed with. The excitation optical system and the fluorescence optical system may coincide, at least in portions, in other words use shared optical components. The excitation optical system and the fluorescence optical system may, however, also be designed to be completely separate from one another, which can help to improve an optical resolution of the temperature measurement. Using the optical fluorescence measurement according to the disclosure, the temperature or the temperature distribution can also be measured deep within the substrate as long as the substrate has adequate transparency for the fluorescence excitation light and the fluorescent light. Typical optical glass materials and in particular ULE® or Zerodur® can be used as the substrate. The temperature measurement can take place without background disturbances (such as may be present, for example, in pyrometry owing to radiant background components). Using the fluorescence temperature measurement, a temperature precision that is adequate for the purposes of projection exposure of 0.1 K or an even higher temperature precision can be achieved. The optical component of the optical assembly may be a component of the illumination optical system, a component of the projection optical system, an EUV collector, or a projection lithography reticle. The fluorescence temperature measurement is not limited to EUV lithography, but can also be used in projection exposure systems working with other wavelengths. The reflective substrate reflects the imaging and/or illumination light. The fluorescent component may be arranged in the interior of the substrate. The fluorescent component may at least in part be arranged spaced apart from a substrate surface.

Erbium as the fluorescent component can allow a precise temperature measurement. A temperature measurement on the basis of a fluorescence intensity measurement is described in the specialist article by A. Pollman et al., Appl. Phys. Lett. 57 (26), 1990. An optical fluorescence temperature measurement based on a decay time of the fluorescence signal is described in a specialist article by Z. Y. Zhang et al., Rev. Sci. Instrum. 68 (7), 1997.

An optical fibre as a component of the excitation optical system or the fluorescence optical system makes it possible to arrange the excitation light source and the fluorescent light detector where installation space is available.

A confocal lens can allow good spatial resolution of the volume fraction in the substrate to be measured with regard to its temperature. If the confocal lens is used with an optical fibre in the excitation optical system or the fluorescence optical system, a fibre end can be imaged with the confocal lens on the volume fraction to be measured. If both the excitation optical system and the fluorescence optical system have their own confocal lens, this leads to the possibility of a very high spatial resolution.

A wavelength of the fluorescence excitation light of 980 nm can be produced, and a detected wavelength of the fluorescent light in the range of 1550 nm can be detected with conventional laser technology, for example with laser diodes, as 1550 nm is a standard telecommunication wavelength.

Advantages of a method for temperature measurement can correspond to those which have already been described above in connection with the optical assembly. When ensuring the presence of the fluorescent component, it can be ensured, in particular, that the fluorescent component is present in the interior of the optical component. A local volume fraction, which is spaced apart from a surface of the substrate, can be measured in the interior of the substrate during the temperature measurement.

The variants of an intensity measurement, a decay time measurement and a wavelength measurement can be used as an alternative to one another or else in combination with one another and allow a precise temperature measurement. During the wavelength measurement, the wavelength of a maximum of a fluorescent light spectrum or else the half-value width of a fluorescence spectrum can be measured in each case with respect to its temperature dependency.

The advantages of an illumination optical system, a projection optical system, a projection exposure system, a production method, and a component according to a production method can correspond to those which have already been discussed above with reference to the optical assembly and the temperature measuring method.

The temperature measuring result with respect to local substrate temperatures or substrate temperature distributions can be used as the actual temperature value for a subsequent temperature control of the optical component.

### BRIEF DESCRIPTION OF THE DRAWINGS

Embodiments of the disclosure will be described in more detail below with the aid of the drawings, in which:

FIG. 1 schematically shows a projection exposure system for EUV microlithography, an illumination optical system and a projection optical system being shown in meridional section;

FIG. 2 schematically shows an optical assembly of the projection exposure system with an optical component guiding imaging or illumination light and an optical fluorescence device for local measurement of the temperature of a substrate of the optical component; and

FIG. 3 shows, in a view similar to FIG. 2, a further configuration of a device for the optical fluorescence local temperature measurement of the substrate.

### DETAILED DESCRIPTION

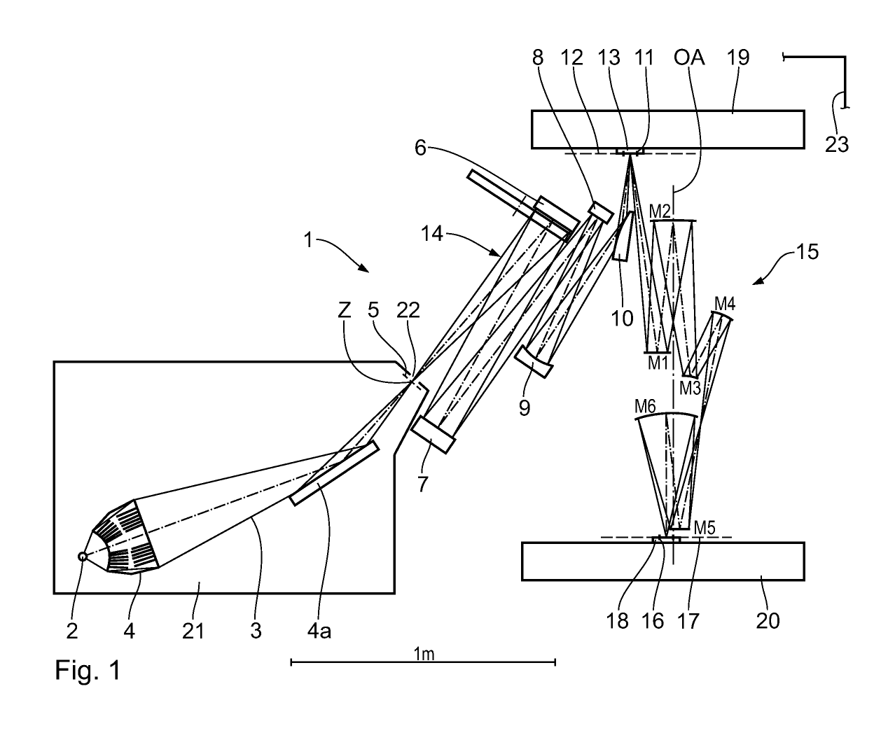

FIG. 1 schematically shows a projection exposure system 1 for EUV microlithography. The projection exposure system 1 has an EUV radiation source 2 for producing a useful radiation bundle 3 of imaging or illumination light. The wavelength of the useful radiation bundle 3 is, in particular, between 5 nm and 30 nm. The EUV radiation source 2 may be an LPP source (Laser-Produced Plasma) or a GDPP source (Gas Discharge-Produced Plasma). Alternatively a DUV radiation source may, for example, also be used, which, for example, produces a useful radiation bundle with a wavelength of 193 nm.

The useful radiation bundle 3 is collected by a collector 4. Corresponding collectors are known, for example, from EP 1 225 481 A, US 2003/0043455 A and WO 2005/015314 A2. After the collector 4 and grazing incidence reflection on a spectral filter 4a, the useful radiation bundle 3 firstly propagates through an intermediate focus plane 5 with an intermediate focus Z and then impinges on a field facet mirror 6. After reflection on the field facet mirror 6, the useful radiation bundle 3 impinges on a pupil facet mirror 7.

After reflection on the pupil facet mirror 7, the useful radiation bundle 3 is firstly reflected on two further mirrors 8, 9. After the N2 mirror, the useful radiation bundle 3 impinges on a grazing incidence mirror 10.

Together with the pupil facet mirror 7, the further mirrors 8 to 10 image field facets of the field facet mirror 6 in an object field 11 in an object plane 12 of the projection exposure system 1. A surface portion to be imaged of a reflective reticle 13 is arranged in the object field 11.

The mirrors 6 to 10, and in a wider sense, also the collector 4, belong to an illumination optical system 14 of the projection exposure system 1.

A projection optical system 15 images the object field 11 in an image field 16 in an image plane 17. A wafer 18 is arranged there. The reticle 13 and the wafer 18 are carried by a reticle holder 19 and a wafer holder 20. The pupil facet mirror 7 lies in an optical plane, which is optically conjugated with a pupil plane of the projection optical system 15.

The object field 11 is arcuate, the meridional section of the illumination optical system 14 shown in FIG. 1 running through an axis of mirror symmetry of the object field 11. A typical extent of the object field 11 in the plane of the drawing of FIG. 1 is 8 mm.

Perpendicular to the plane of the drawing of FIG. 1, a typical extent of the object field 11 is 104 mm. A rectangular object field, for example with a corresponding aspect ratio of 8 mm×104 mm is also possible.

The projection optical system 15 is a mirror optical system with six mirrors M1 to M6, which are numbered consecutively in FIG. 1 in the order of the imaging beam path of the projection optical system 15 between the object field 11 and the image field 16 in the image plane 17. In FIG. 1, an optical axis OA of the projection optical system 15 is indicated. A reduction factor of the projection optical system 15 is 4×.

Each of the mirrors 6 to 10 of the illumination optical system 14 and M1 to M6 of the projection optical system 15 is an optical component with an optical face which can be impinged upon by the useful radiation bundle 3. The reticle 13 is also an optical component of this type.

The light source 2, the collector 4 and the spectral filter 4a are accommodated in a source chamber 21, which can be evacuated. The source chamber 21 has a through-opening 22 for the useful radiation bundle 3 in the region of the intermediate focus Z. Accordingly, the illumination optical system 14 following the intermediate focus Z, and the projection optical system 15 and the reticle holder 19 and the wafer holder 20 are housed in an illumination/projection optical system chamber 23, which can also be evacuated and of which FIG. 1 schematically merely shows a wall portion in the region of a chamber corner. The illumination/projection optical system chamber 23 can also be evacuated.

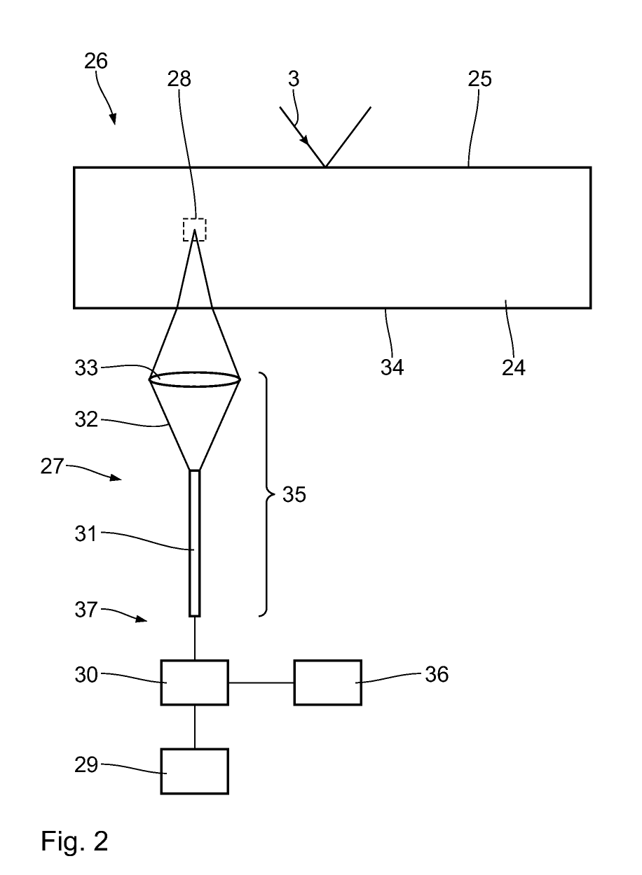

FIG. 2 schematically shows a substrate 24 of an optical component of the optical system of the projection exposure system 1 guiding the imaging or illumination light 3, in other words a component of the illumination optical system 14 or the projection optical system 15. The material of the substrate 24 may be ULE® or Zerodur®. The substrate 24 has a reflection face 25 to reflect the incident imaging or illumination light 3, which is shown schematically in FIG. 2. The reflection face 25 may carry a reflective coating, not shown in the drawing, which is optimised for the wavelength of the illumination or imaging light 3 and for its angle of incidence on the reflection face 25. The reflection face 25 is shown schematically in FIG. 2 in section as a face running in a planar manner. This may just as well be a curved face, for example a convex, concave or toric face. The reflection face 25 can be formed as a spherical face, an aspherical face or as a freeform face. The substrate 24 according to FIG. 2 is part of an optical assembly 26. This also includes, apart from the optical component with the substrate 24, a device 27 for at least local measurement of the temperature of the substrate 24. A local volume fraction 28 in the interior of the substrate 24, which is indicated by dashed lines in FIG. 2, is measured.

The temperature measuring device 27 has an excitation light source 29 to produce fluorescence excitation light. The excitation light source 29 is shown schematically in FIG. 2. This may be a laser, which produces light with an infrared wavelength of 980 nm. The fluorescence excitation light, proceeding from the excitation light source 29, firstly passes through an optical outcoupling component 30 and is subsequently coupled into an optical fibre 31. After leaving the fibre 31, the fluorescence excitation light, along a beam path 32 indicated schematically in FIG. 2, passes through a lens 33 arranged confocally and arranged between the optical fibre 31 and the substrate 24. The fluorescence excitation light then passes along the further course of the beam path 32 into the substrate 24, where it is refracted on an entry face 34, which is a side, in other words the rear side, of the substrate 24 opposing the reflection face 25. The entry face 34 may carry an anti-reflection coating for the light wavelengths entering and/or leaving there. After passing through the entry face 34, the fluorescence excitation light is focused in the volume fraction 28.

A fluorescent component contained in the mirror substrate 24 is excited to fluorescence by the fluorescence excitation light focused in the volume fraction 28. Components of the substrate 24 that are already present in any case in the mirror material of the substrate 24 can be used to excite fluorescence. Alternatively, a fluorescent doping may be introduced into the material of the substrate 24. This may be erbium. A concentration of the fluorescent component may be 100 ppm or more.

The optical fibre 31 and the lens 33 are an excitation optical system 35 to guide the fluorescence excitation light to the volume fraction 28 to the fluorescent component of the substrate 24.

The fluorescent light has a wavelength of 1550 nm.

The fluorescent light produced is in turn guided via the beam path 32, the lens 33 and the optical fibre 31. Once the fluorescent light has left the optical fibre 31, the fluorescent light is outcoupled at the optical outcoupling component 30, in other words separated from the incident beam path of the fluorescence excitation light. After the outcoupling at the optical outcoupling component 30, the fluorescent light produced impinges on a fluorescent light detector 36.

The lens 33, the optical fibre 31 and the optical outcoupling element 30 are components of a fluorescence optical system 37 to guide the fluorescent light from the volume fraction 28 to the fluorescent light detector 36.

The lens 33 and the optical fibre 31 in the embodiment according to FIG. 2 are simultaneously components of the excitation optical system 35 and the fluorescence optical system 37. Components, which are simultaneously impinged upon by the fluorescence excitation light and the fluorescent light, can carry, on entry and exit faces, anti-reflection coatings for the wavelengths both of the fluorescence excitation light and of the fluorescent light. An exception to this is formed by the optical outcoupling component 30, which carries an anti-reflection coating for the fluorescence excitation light and a highly reflective coating for the fluorescent light. The outcoupling component 30 is therefore configured as a dichroic beam splitter. The outcoupling component 30 can also be configured as a beam splitter acting in a different manner, for example as an optical polarisation beam splitter.

Because of the confocal arrangement of the lens 23, a high spatial resolution of the fluorescent light detection is produced. The volume fraction 28, within which the fluorescence excitation takes place and within which a fluorescent light scanning takes place, is correspondingly small.

For at least local measurement of the temperature of the substrate 24, the procedure is as follows: it is firstly ensured that the substrate 24 contains a fluorescent component. This fluorescent component may, for example, be present in any case in the material of the substrate 24 in the form of an impurity or be introduced deliberately. It is then predetermined how large the volume fraction 28 is to be, within which a fluorescence excitation is to take place. The excitation optical system 35 and the fluorescence optical system 37 and also the excitation light source 29 are then provided in a configuration ensuring that a fluorescent light detection takes place in the volume fraction 28 in a size corresponding to the predetermined volume fraction size, in other words the predetermined spatial resolution of the detection. The fluorescent component in the volume fraction 28 is then excited to fluorescence with the fluorescence excitation light and the fluorescent light produced in the volume fraction 28 is detected by the fluorescent light detector 36.

This measuring method can firstly take place at a series of known temperatures of the substrate 24 in the temperature range to be measured. The temperature measuring device 27 is calibrated in this manner. A temperature-dependent variation of an intensity of the detected fluorescent light, a decay time of the detected fluorescent light or a wavelength of the detected fluorescent light can be used as the measuring variable.

During the intensity measurement, the intensity of the fluorescent light is detected by the fluorescent light detector 36. Very sensitive intensity detectors exist for a fluorescent light wavelength in the near infrared (NIR) range, in other words, for example in the range of 1550 nm.

To detect a decay time of the fluorescent light, the excitation of the volume fraction 28 takes place with a temporally limited fluorescence excitation light pulse. Depending on the time course of the fluorescence excitation, a fluorescent light response of the fluorescence excitation is then measured with the fluorescent light detector 36 with time resolution and a decay time constant of the fluorescent light is determined therefrom. This decay time also has a temperature dependency, which can firstly be determined by a calibration and then used for temperature measurement.

If the wavelength of the fluorescent light is detected for temperature measurement, the fluorescent light detector 36 has a spectral sensitivity. This can be produced by a spectral filtering or by a unit spectrally separating the fluorescent light, for example a grating or a dispersive element. The wavelength of the fluorescent light, at a fixed wavelength of the fluorescence excitation light, is temperature-dependent. After a corresponding calibration of the temperature dependency of a wavelength displacement of the fluorescent light, a temperature measurement can in turn take place based on the measured fluorescent light wavelength. Accordingly, a temperature measurement can also take place based on a temperature dependency of a half-value width of a fluorescence spectrum.

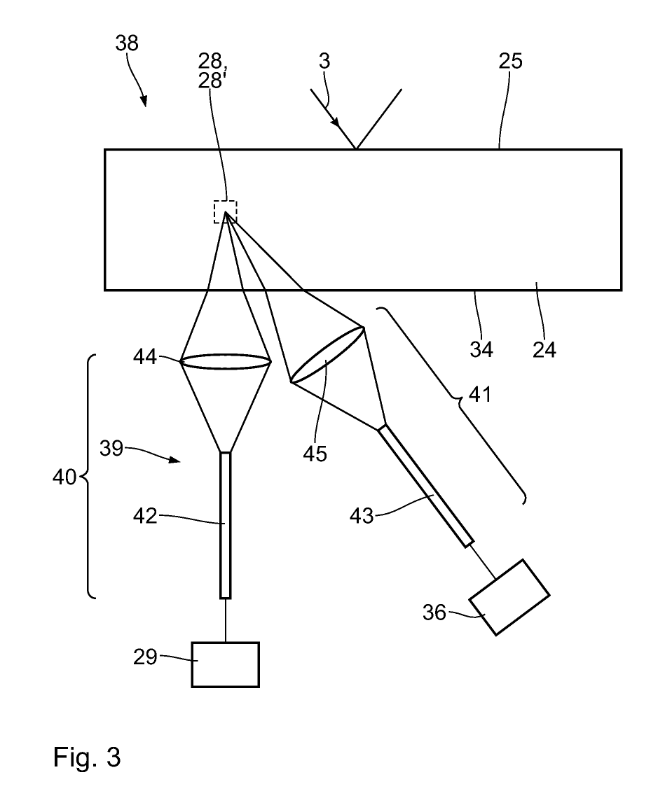

FIG. 3 shows a further embodiment of an optical assembly 38 with a temperature measuring device 39. Components which correspond to those which have already been described above with reference to FIGS. 1 and 2 and, in particular, with reference to FIG. 2 have the same reference numerals and will not be discussed again in detail.

In the temperature measuring device 39, an excitation optical system 40 and a fluorescence optical system 41 are designed to be separate from one another. The two optical systems 40, 41 in each case have an optical fibre 42, 43 and a confocally arranged lens 44, 45 in accordance with the structure of the excitation optical system 35 of the configuration according to FIG. 2. The excitation optical system 40 can now be optimised with regard to the design of the individual components to the wavelength of the fluorescence excitation light. The components of the fluorescence optical system 41 may have a corresponding optimisation to the wavelength of the fluorescent light. In the temperature measuring device 39, the optical outcoupling component 30 is dispensed with. The excitation light source 29 can be arranged directly in front of the optical fibre 42 and the fluorescent light detector 36 can be arranged directly behind the optical fibre 43. A volume fraction 28 of the fluorescence excitation with the fluorescence excitation light can coincide precisely with a detection volume fraction 28′ of the fluorescence optical system 41. It is alternatively possible to allow the detection volume fraction 28′ to overlap only partially with the excitation volume fraction 28, which again increases a spatial resolution of a temperature measurement using the temperature measuring device 39.

A temperature measuring method using the temperature measuring device 39 corresponds to that which was already described above in conjunction with the temperature measuring device 27.

The substrate 24 can be measured at various points with a plurality of the above-described temperature measuring devices 27 and/or 39. It is possible via a combination of this type of measuring devices to measure a temperature distribution within the substrate 24.

A resolution of the temperature measurement in the region of 0.1 K or else a still better temperature resolution can be achieved with the temperature measuring devices 27, 39. The volume fractions 28, 28′, as shown in FIGS. 2 and 3, can be located a long way into the interior of the substrate 24. In principle, the volume fractions 28, 28′ may be arranged at any location within the substrate 24 or even within a coating on the substrate 24. The location, the temperature of which is to be measured, can be selected in this manner.

During the projection exposure, the reticle 13 and the wafer 18, which carries a coating which is light-sensitive to the EUV illumination light 3, are provided. At least one portion of the reticle 13 is then projected on to the wafer 18 with the aid of the projection exposure system 1. Finally, the light-sensitive layer exposed by the EUV illumination light 3 is developed on the wafer 18. The microstructured or nanostructured component, for example a semiconductor chip, is produced in this manner.

The embodiments described above were described with the aid of EUV illumination. As an alternative to EUV illumination, UV illumination or VUV illumination can also be used, for example with illumination light with a wavelength of 193 nm.

What is claimed is:

1. An optical assembly, comprising:
an optical component configured to guide imaging light and/or illumination light, the optical component comprising a reflective substrate which comprises a fluorescent component;
a light source configured to produce fluorescence excitation light;
a first optical system configured to guide the fluorescence excitation light to the fluorescent component to cause the fluorescent component to produce fluorescent light;
a fluorescent light detector; and
a second optical system configured to guide the fluorescent light to the fluorescent light detector,
wherein the optical assembly is a projection lithography optical assembly.

2. The optical assembly of claim 1, wherein the fluorescent component comprises erbium.

3. The optical assembly of claim 1, wherein the first optical system comprises a fiber.

4. The optical assembly of claim 1, wherein the second optical system comprises a fiber.

5. The optical assembly of claim 1, wherein the first optical system comprises a confocal lens.

6. The optical assembly of claim 1, wherein the second optical system comprises a confocal lens.

7. The optical assembly of claim 1, wherein the light source is configured to provide fluorescence excitation light having a wavelength of 980 nm, and the fluorescent light has a wavelength in the range of 1550 nm.

8. The optical assembly of claim 1, wherein the first and second optical systems have at least one common component.

9. An illumination optical system comprising an optical assembly according to claim 1, wherein the illumination system is configured to illuminate an object field of a lithography projection exposure system.

10. A projection optical system comprising an optical assembly according to claim 1, wherein the projection optical system is configured to image an object field of a lithography projection exposure system.

11. A projection exposure system, comprising:
an optical system comprising an optical assembly according to claim 1,
wherein the projection exposure system is a lithography projection exposure system.

12. The projection exposure system of claim 11, wherein the optical system is an illumination system configured to illuminate an object field of the lithography projection exposure system.

13. The projection exposure system of claim 11, wherein the optical system is a projection optical system configured to image an object field of the lithography projection exposure system.

14. A method, comprising:
exciting a fluorescent component of a projection lithography optical component with fluorescence excitation light, thereby generating fluorescent light from the fluorescent component; and
detecting the fluorescent light with a fluorescence detector.

15. The method of claim 14, further comprising detecting a temperature of the projection lithography optical component.

16. The method of claim 14, wherein the projection lithography optical component comprises a substrate which comprises the fluorescent component.

17. The method of claim 14, further comprising measuring an intensity of the detected fluorescent light.

18. The method of claim 14, further comprising measuring a decay time of the detected fluorescent light.

19. The method of claim 14, further comprising measuring a wavelength of the detected fluorescent light.

20. The method of claim 14, further comprising:
projecting at least a part of a reticle (13) on to a region of a light-sensitive layer of a wafer via a projection exposure system which comprises the projection lithography optical component.

21. The method of claim 20, further comprising monitoring a temperature of the optical component based on the detected fluorescent light.
